(19) United States
(12) Patent Application Publication
(10) Pub. No.: US 2016/0117177 A1
(43) Pub. Date: Apr. 28, 2016

(54) MONITORING SYSTEM AND MONITORING METHOD FOR SERVER

(71) Applicants: HONG FU JIN PRECISION INDUSTRY (ShenZhen) CO., LTD., ShenZhen (CN); HON HAI PRECISION INDUSTRY CO., LTD., New Taipei (TW)

(72) Inventor: CAI-XIANG XING, Shenzhen (CN)

(21) Appl. No.: 14/569,181

(22) Filed: Dec. 12, 2014

(30) Foreign Application Priority Data
Oct. 28, 2014 (CN) 201410585800.4

(51) Int. Cl. G06F 9/44; G06F 11/30; G06F 11/22; G06F 13/38

(52) U.S. Cl. CPC G06F 9/4416; G06F 9/4411; G06F 13/385; G06F 11/3051; G06F 11/2289

(57) ABSTRACT

Monitoring system includes a monitor device and an electronic device with a plurality of hardware data. The electronic device includes a Baseboard Management Controller (BMC) and an analyzing module. The analyzing module includes a three dimensional controlling sub-module and a data explaining sub-module. The BMC obtains a health information of the electronic device. The three dimensional controlling sub-module obtains the hardware data to generate an original three dimensional data for sending to the data explaining sub-module. The data explaining sub-module explains the health information to combine the original three dimensional data to obtain a combined three dimensional data of the electronic device onto the monitor device.

### FIELD

The subject matter herein generally relates to a monitoring system and a monitoring method.

### BACKGROUND

Servers are used in data communication, data processing, storage and management of data, and management consulting. Because the system architecture of the server is complex and strict, engineers need to combine theories and practices on a real server. When the server needs to be monitored, a Baseboard Management Controller (BMC) is inserted on a motherboard of the server to monitor the server, and a monitor data of the BMC can be displayed on a user interface.

### BRIEF DESCRIPTION OF THE DRAWINGS

Implementations of the present technology will now be described, by way of example only, with reference to the attached figures.

FIG. 1 is a diagrammatic view of an embodiment of a monitoring system.

FIG. 2 is a block diagram of one embodiment of function modules of a monitoring system.

FIG. 3 is a flowchart of one embodiment of a monitoring method using the monitoring system of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to monitoring system including a monitor device and an electronic device with a plurality of hardware data. The electronic device comprises a Baseboard Management Controller (BMC) and an analyzing module. The analyzing module comprises a three dimensional controlling sub-module and a data explaining sub-module. The BMC obtains health information of the electronic device. The three dimensional controlling sub-module obtains the hardware data to generate an original three dimensional data for sending to the data explaining sub-module. The data explaining sub-module explains the health information to combine the original three dimensional data to obtain a combined three dimensional data of the electronic device onto the monitor device.

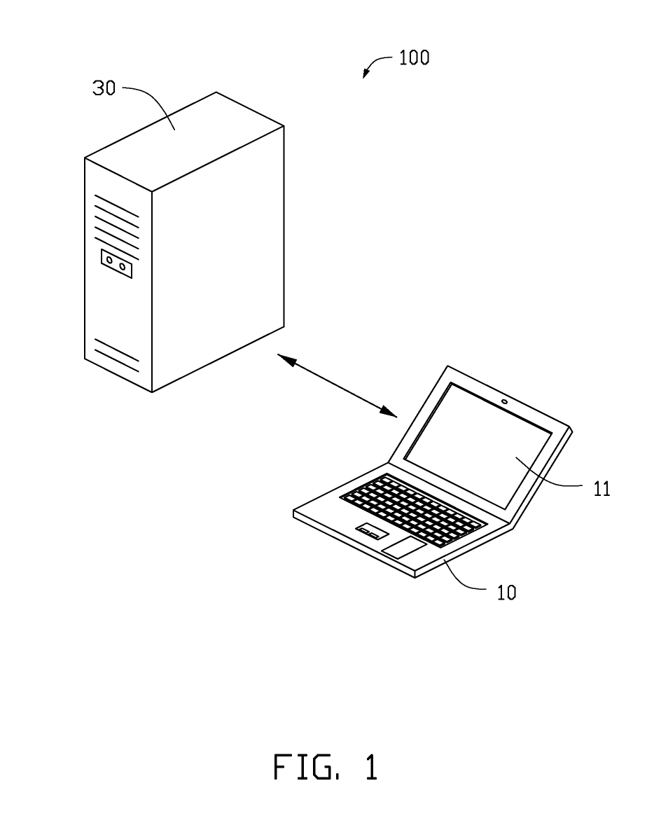

FIG. 1 illustrates an embodiment of a monitoring system 100. The monitoring system 100 can comprise a monitor device 10 and an electronic device 30 connected to the monitor device 10 wirelessly or wired. In at least one embodiment, the monitor device 10 can be a personal computer, and the electronic device 30 can be a server.

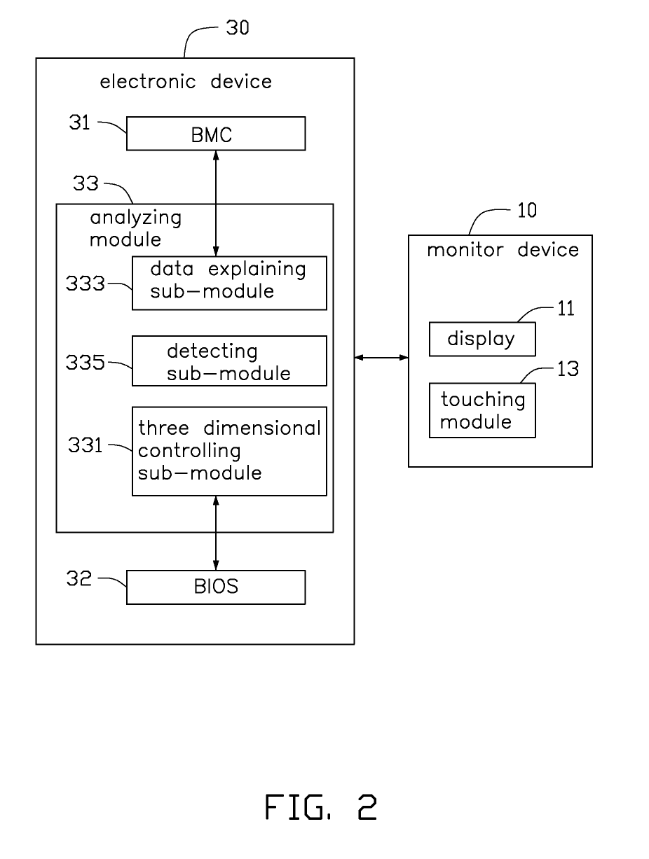

FIG. 2 illustrates an embodiment of the monitoring system 100. The monitoring device 10 can comprise a display 11 and a touching module 13. The display 11 is used to display data from the electronic device 30. The touching module 13 is used to response a code from the monitoring device 10.

The electronic device 30 comprises a Baseboard Management Controller (BMC) 31, a Base Input Output System (BIOS) 32, and an analyzing module 33. The BMC can be used to monitor the electronic device 30 via a sensor (not shown) to obtain a plurality of current physical variable value of an electronic component, such as an expansion card, a heat sink, a power supply. The plurality of current physical variable value can be a current temperature value, a current humidity value, a voltage value, a current operation system value, and so on. If anyone of the plurality of current physical variable value is out of a corresponding predetermined value range, for example, if the current temperature value is out of a predetermined value range or if the current humidity value is out of a predetermined value range, the BMC 31 can detect the electronic device 30 is unhealthy. The health information of the electronic device 30 can be stored in the BMC 31.

The BIOS 32 can be a plurality of processes that is stored in a Read Only Memory (ROM) on a circuit board (not shown) of the electronic device 30, and a plurality of hardware data of the electronic device 30 can be stored in the BIOS 32. The hardware data can comprise a plurality of base input/output program, a system setting information, self-check program, and an automatic starting program.

The analyzing module 33 comprises a three dimensional controlling sub-module 331, a data explaining sub-module 333, a detecting sub-module 335. The three dimensional controlling sub-module 331 is coupled to the BIOS 32 and the data explaining sub-module 333. The three dimensional controlling sub-module 331 is used to obtain the hardware data from the BIOS 32 to generate original three dimensional data of the electronic device 30 for sending to the data explaining sub-module 333.

The data explaining sub-module 333 is coupled to the BMC 31 to be used to read the health information in the BMC 31. The data explaining sub-module 333 is further used to explain the health information to combine the original three dimensional data of the electronic device 30, and a combined three dimensional data of the electronic device 30 can be obtained by the data explaining sub-module 333. The combined three dimensional data of the electronic device 30 can be sent by the data explaining sub-module 333, and the electronic device 30 can be shown in the display 11 using a three dimensional drawing. When the touching module 13 clicks an electronic component of the three dimensional drawing of the electronic device 30, and the health information of the electronic component can be shown in a dialog box. For example, if an expansion card is clicked, the health information of the expansion card is shown in the dialog box, including temperature health information, humidity health information, voltage health information, and operating health information. For example, if the temperature is healthy, “the temperature is OK” will be shown in the dialog box, if the temperature is unhealthy, “the temperature is critical” will be shown in the dialog box. Similarly, if the humidity is healthy, “the humidity is OK” will be shown in the dialog box, if the humidity is unhealthy, “the humidity is critical” will be shown in the dialog box. Therefore, when anyone of the plurality of electronic components of the electronic device 30 is clicked, and the health information can be directly shown on the display 11.

The detecting sub-module 335 is coupled to the three dimensional controlling sub-module 331 to detect whether the original three dimensional data of the electronic device 30 is stored in the three dimensional controlling sub-module 331.

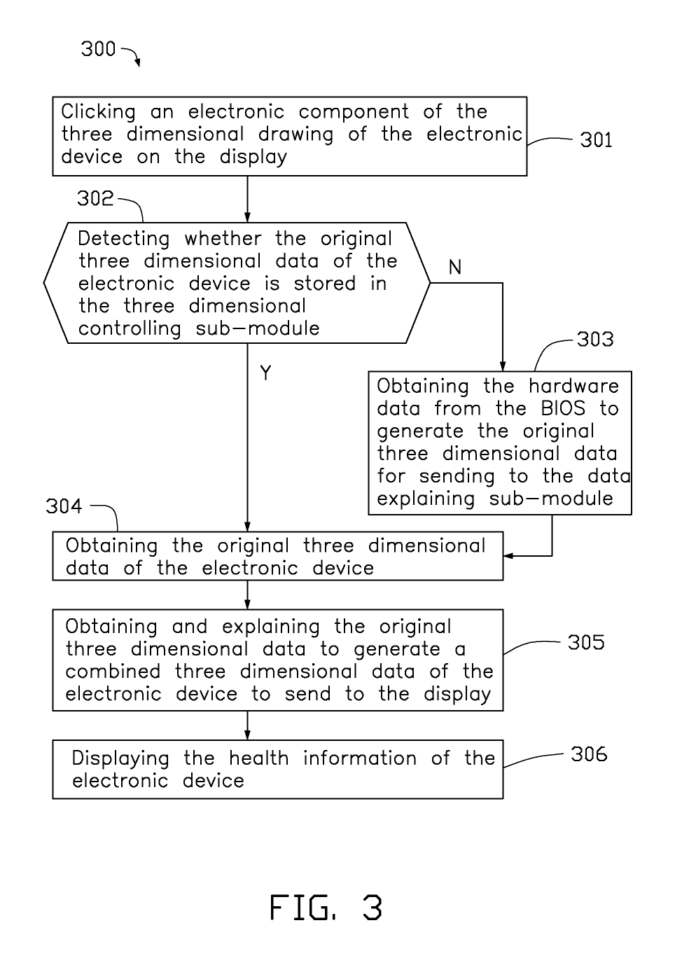

Referring to FIG. 3, a flowchart is presented in accordance with an example embodiment which is being thus illustrated. The example method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods or subroutines, carried out in the exemplary method 300. Additionally, the illustrated order of blocks is by example only and the order of the blocks can change according to the present disclosure. The exemplary method 300 can begin at block 302.

At block 301, the touching module 13 clicks an electronic component of the three dimensional drawing of the electronic device 30 on the display 11 to obtain the health information of the electronic component, such as an expansion card.

At block 302, the detecting sub-module 335 detects whether the original three dimensional data of the electronic device 30 is stored in the three dimensional controlling sub-module 331. If no, goes on to block 303, and if yes, goes on to block 304.

At block 303, the three dimensional controlling sub-module 331 obtains the hardware data from the BIOS 32 to generate the original three dimensional data of the electronic device 30 for sending to the data explaining sub-module 333.

At block 304, the data explaining sub-module 333 obtains the original three dimensional data of the electronic device 30.

At block 305, the data explaining sub-module 333 obtains and explains the original three dimensional data of the electronic device 30 to generate a combined three dimensional data of the electronic device 30 to send to the display 11.

At block 306, the display 11 displays the health information of the electronic device 30. For example, the health information of the expansion card is shown in the dialog box, including temperature health information, humidity health information, voltage health information, and operating health information. For example, if the temperature is healthy, “the temperature is OK” will be shown in the dialog box, if the temperature is unhealthy, “the temperature is critical” will be shown in the dialog box. Similarly, if the humidity is healthy, “the humidity is OK” will be shown in the dialog box, if the humidity is unhealthy, “the humidity is critical” will be shown in the dialog box. Therefore, when anyone of the plurality of electronic components of the electronic device 30 is clicked, and the health information can be directly shown in the display 11.

The embodiments shown and described above are only examples. Many details are often found in the art such as the other features of a monitoring system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A monitoring system comprising:
a monitor device; and
an electronic device coupled to the monitor device and having a plurality of hardware data; and the electronic device comprising a Baseboard Management Controller (BMC) and an analyzing module; the analyzing module comprising a three dimensional controlling sub-module and a data explaining sub-module;
wherein the BMC is configured to obtain a health information of the electronic device, the three dimensional controlling sub-module is configured to obtain the hardware data in the electronic device to generate an original three dimensional data of the electronic device for sending to the data explaining sub-module, and the data explaining sub-module is configured to explain the health information to combine the original three dimensional data to obtain a combined three dimensional data of the electronic device onto the monitor device.

2. The monitoring system of claim 1, wherein the electronic device comprises a Base Input Output System (BIOS), and the hardware data is stored in the BIOS.

3. The monitoring system of claim 2, wherein the analyzing module further comprises a detecting sub-module, and the detecting sub-module is coupled to the three dimensional controlling sub-module to detect whether the original three dimensional data is stored in the three dimensional controlling sub-module.

4. The monitoring system of claim 1, wherein the health information comprises a temperature health information, a humidity health information, a voltage health information, and an operating health information.

5. The monitoring system of claim 1, wherein the monitor device further comprises a touching module, and the touching module is configured to click an electronic component of the combined three dimensional data of the electronic device.

6. The monitoring system of claim 1, wherein the monitor device is a personal computer, and the electronic device is a server.

7. The monitoring system of claim 1, wherein the combined three dimensional data of the electronic device is shown on a display using a three dimensional drawing.

8. The monitoring system of claim 1, wherein the hardware data comprises a plurality of base input/output program, a system setting information, a self-check program, and an automatic starting program.

9. A monitoring method comprising:
obtaining a health information of a electronic device by a Baseboard Management Controller (BMC) in an electronic device;
obtaining a hardware data in the electronic device to generate an original three dimensional data of the electronic device for sending to a data explaining sub-module by a three dimensional controlling sub-module in the electronic device; and
explaining the health information to combine the original three dimensional data to obtain a combined three dimensional data of the electronic device onto a monitor device by the data explaining sub-module in the electronic device.

10. The monitoring method of claim 9, further comprising: storing hardware data in a Base Input Output System (BIOS) of the electronic device.

11. The monitoring method of claim 9, further comprising: detecting whether the original three dimensional data is stored in the three dimensional controlling sub-module by a detecting sub-module in an analyzing module.

12. The monitoring system of claim 9, wherein the health information comprises a temperature health information, a humidity health information, a voltage health information, and an operating health information.

13. The monitoring method of claim 9, wherein clicking an electronic component of the combined three dimensional data of the electronic device by a touching module of the monitor device.

14. The monitoring method of claim 9, wherein the monitor device is a personal computer, and the electronic device is a server.

15. The monitoring system of claim 9, wherein showing the combined three dimensional data of the electronic device using a three dimensional drawing by onto a display of the monitor device.

16. The monitoring system of claim 9, wherein the hardware data comprises a plurality of base input/output program, a system setting information, a self-check program, and an automatic starting program.
